(19) United States
(12) Patent Application Publication
(10) Pub. No.: US 2001/0055212 A1
(43) Pub. Date: Dec. 27, 2001

(54) Automobile visual message system

(76) Inventor: Arthur R. Phillips, Aspen, CO (US)

Correspondence Address: DORSEY & WHITNEY, LLP, SUITE 4700, 370 SEVENTEENTH STREET, DENVER, CO, 80202-5647, US

(21) Appl. No.: 09/887,868

(22) Filed: Jun. 22, 2001

Related U.S. Application Data
(60) Provisional application No. 60/213,709, filed on Jun. 22, 2000.

(51) Int. Cl. B60Q 1/00

(52) U.S. Cl. 362/487

(57) ABSTRACT

A vehicle light lens system capable of displaying message logos, and more particularly relates to such lenses that incorporate message logos into the body of the lens thereby forming a one-piece lens capable of displaying message logos. The light lens system includes a lens body that has an observer facing side and an opposite light source facing side. The body has at least one contrast visibly discernible from the observer facing side. The contrast is provided in the shape of a desired message logo. The contrast may reflect light and/or be illuminated by a light source.

### CROSS-REFERENCE TO RELATED APPLICATION

This application claims the benefit of provisional patent application No. 60/213709, filed Jun. 22, 2000. This application is hereby incorporated by reference as if fully disclosed herein.

### FIELD OF THE INVENTION

The present invention relates to a vehicle light lens system capable of displaying message logos, and more particularly relates to such lenses that incorporate message logos into the body of the lens thereby forming a one-piece lens capable of displaying message logos.

### BACKGROUND OF THE INVENTION

Improving vehicle safety has long been a subject of public concern. As the number of vehicles has increased, so has the number of accidents. A major cause of accidents is driver error. One such error is that drivers often forget to follow basic accepted safety precautions, such as signaling before turning.

The typical way vehicle manufacturers attempt to improve vehicle safety is through technological advances such as anti-lock brake systems (ABS) and air-bags. In making each technological advance, vehicle manufacturers invest in costly research and development projects. Correspondingly, the cost of a given vehicle rises with each technological advance. While advancing technology can improve vehicle safety, it usually fails to reduce the main cause of accidents—driver error. There is a need to both improve vehicle safety by reducing driver error and reduce the costs to manufacturers associated with improving vehicle safety.

Another more recent public concern related to vehicle safety is the increase in the phenomenon known as “road rage.” The average commute time has increased correspondingly with the number of vehicles thereby causing increased frustration in drivers. When drivers' frustration levels reach the stage referred to as road rage, drivers have been known to drive aggressively or even commit violent acts.

Currently, automobile manufacturers have done little to address the growing problem with road rage. There is a need for an inexpensive, simple way to attempt to minimize the incidents of road rage.

### SUMMARY OF THE INVENTION

The present invention pertains to a lens capable of displaying message logos and suitable for use in a vehicle lighting assembly. More specifically, the present invention provides a novel and non-obvious vehicle light lens body with message logos that are incorporated in and/or integral to the lens body.

In the present invention, the inventor has discovered a simple, inexpensive, and courteous way to reduce driver error, improve vehicle safety, and minimize the occurrence of road rage. The inventor's inclusion of message logos in vehicle light lenses utilizes the accepted method of repetitive learning to repeatedly remind drivers of basic accepted safety precautions such as signaling before turning, thus helping to diminish frustrations due to not signaling. In addition, the present invention simplifies the inclusion of message logos in vehicle light lenses by incorporating the message logo portion into the vehicle light lens body thereby creating a one-piece lens capable of displaying message logos.

In one embodiment of the present invention, the lens body has an observer facing side and an opposite light source facing side. The body has at least one contrast visibly discernible from the observer facing side. The contrast is provided in the shape of a desired message logo. The contrast may reflect light and/or be illuminated by a light source.

One advantage of the instant vehicle light lens is having message logos developed from at least one contrast in the body and visibly discernible from the observer facing side, wherein the contrast(s) is incorporated in the lens body and not developed from separate parts or inserts.

Another advantage of the present invention is that the message logos are developed from at least one contrast in the body and visibly discernible from the observer facing side, wherein the contrast(s) may be light reflective and/or are illuminated by a light source.

Yet another advantage is a novel and non-obvious method for manufacturing the present invention vehicle light lens.

The foregoing and other features, utilities and advantages of the invention will be apparent from the following more particular description of embodiments of the invention as illustrated in the accompanying drawings.

### BRIEF DESCRIPTION OF THE DRAWING

FIG. 1 is the rear of a motor vehicle showing a vehicle lighting assembly which incorporates the present invention lens.

FIG. 2A is an exploded view of a vehicle light assembly showing an illuminating light source.

FIG. 2B is an exploded view of a vehicle light assembly a reflective light source.

FIG. 3 is an individual reflective vehicle light lens according to the present invention without illumination from a lighting source.

FIG. 4 is an individual non-reflective vehicle light lens according to the present invention without illumination from a lighting source.

FIG. 5 is an individual vehicle light lens according to the present invention with illumination from a lighting source.

### DETAILED DESCRIPTION OF THE PREFERRED EMBODIMENT

As shown in the drawings, a vehicle 100 is provided with a rear lighting system that includes rear brake lights 110, rear turn signal lights 120, and rear running lights 130. The following description generally refers to “vehicle lights.” Vehicle lights include all lights typically included in a rear lighting system of a vehicle.

One embodiment of the present invention relates to the rear vehicle lighting assemblies and specifically to the lens portion of such assemblies. The present invention message logo lens may be included on new rear vehicle lighting assemblies or retrofitted for use on existing rear vehicle lighting assemblies. In other embodiments of the present invention, the present invention message logo lens may be included on any of the vehicle lighting assemblies including the front and rear turn signal lighting assemblies.

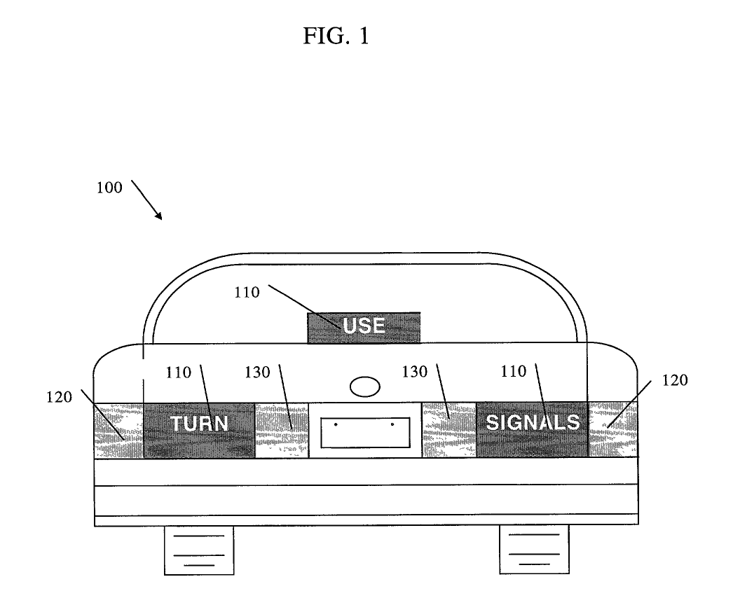

Referring to FIGS. 1-5, FIG. I shows the back end of a vehicle 100 having rear brake lights 110, rear turn signals 120, and rear running lights 130. The rear brake lights 110 of the vehicle 100 depicted include lenses that have the message logo, “USE TURN SIGNALS.” While one embodiment of the present invention includes a safety message displayed in the rear brake lights 110, advertising, political, and other messages could be incorporated in the present invention rear brake light 110 lens or any of the other light lenses on the rear of the vehicle (e.g., “BE COURTEOUS”, “ROAD RAGE”, “DON'T TAILGATE”, “FOCUS ON DRIVING”, “FOCUS”, “USE REARVIEWS”, “DRIVE SPEED LIMIT”, “THINK”, “LOCK YOUR CAR”, “SMILE BE HAPPY”, “LIFE IS GREAT”, etc.) The present invention lens could be utilized on a single lens for a single lens message logo or on multiple lenses for a multiple lens message logo. The present invention may include any message logo as determined by the vehicle or lens manufacturer.

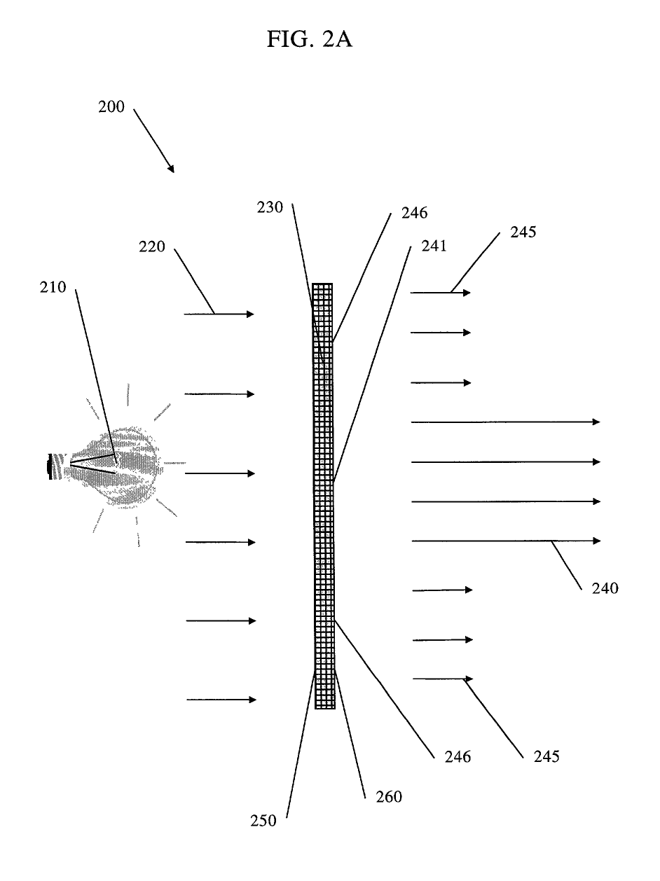

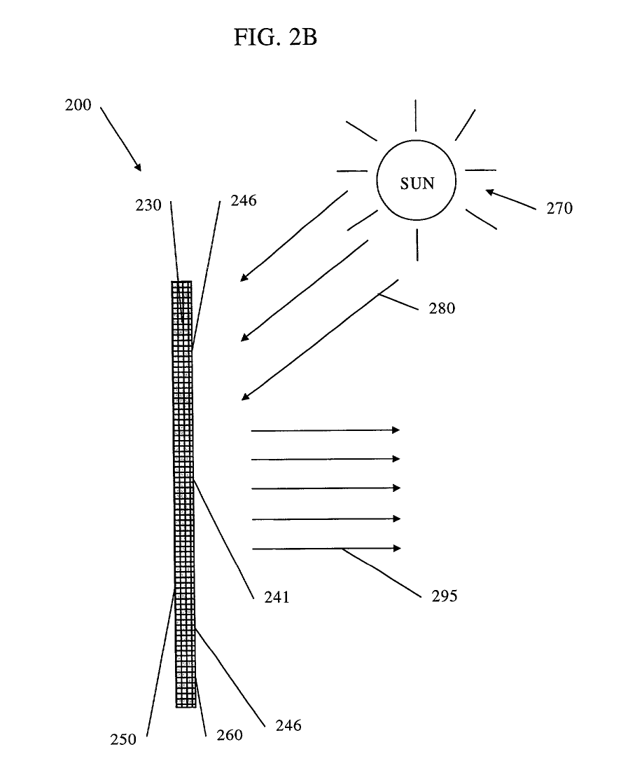

As shown in FIGS. 2A and 2B, the message logo portion may become visibly discernible on the observer facing side 260 of the lens body 230 in at least two ways: 1) by directing non-natural light 220 at the light source facing side 250 of the lens body 230 thereby causing the message logo portion 241 to become illuminated in contrast to the surrounding lens area 246; or 2) by directing natural or non-natural light 280 toward the observer facing side 260 of the message logo portion 241 thereby causing reflected light 295 to reflect from the message logo portion 241 of the lens body 230 in contrast to the surrounding lens area 246.

FIG. 2A shows an exploded view of the vehicle light assembly 200 illuminated by a man-made light source 210, including an illuminating light source 210, light 220 from the source 210, a lens body 230 having a light source facing side 250, an observer facing side 260, a message logo portion 241, and a surrounding area portion 246, illuminated light 240 passing through the message logo portion 241 of the lens body 230, and illuminated light 245 passing through the surrounding area portion 246 of the lens body 230. Light 220 is created for this purpose by an illuminating light source 210 and is directed at the light source facing side 250 of the lens body 230 by turning the vehicle lights on to illuminate the light source 210. The light 220 from the light source 210 illuminates the message logo portion 241 such that it is visibly discernible in contrast to the surrounding lens area portion 246 on the observer facing side 260 of the lens body 230. For instance, the light 240 coming through the logo portion 241 can be brighter than the light 245 coming through the surrounding area 246. This can be done by making the logo portion 241 thinner than the surrounding area 246. Conversely, this can also be done by making the logo portion 241 thicker than the surrounding area 246. If the logo portion 241 is thicker than the surrounding area 246, more light would pass through the surrounding area 246 than the logo portion 241 thereby causing the logo portion 241 to both appear darker than the surrounding area 246 and be visibly discernible.

FIG. 2B shows an exploded view of the vehicle light assembly 200 having reflective materials incorporated into the lens body 230, including a lens body 230 having a light source facing side 250, an observer facing side 260, a message logo portion 241, and a surrounding area portion 246, natural or non-natural light 280 directed at the observer facing side 260 of the lens body 230, and reflected light 295 reflecting from the observer facing side 260 of the lens body 230. As shown in FIG. 2B, if light reflective materials, which are known or available in the art, are incorporated into the message logo portion 241, the message logo portion 241 may become visibly discernible on the observer facing side 260 of the lens body 230 when natural or non-natural light 280 is directed at the observer facing side 260. The reflective material is positioned in or on the lens body 230 to spell out the desired message logo. The light reflective message logo portion 241 reflects the reflected light 295 thereby causing the message logo portion 241 to be visibly discernible. The reflective material causes the reflected light 295 from the message logo 241 to be either brighter or darker than the surrounding lens material 246 to create a contrast in order to see the message logo 241. The present invention is contemplated to work with either an illuminated light source 210 or a reflective light source 270, or both.

The present invention includes vehicle light lenses having any combination of reflective and non-reflective materials. The present invention also includes lens bodies having different shapes, sizes, thickness, and colors. The present invention further includes vehicle light lenses that incorporate materials having holographic characteristics.

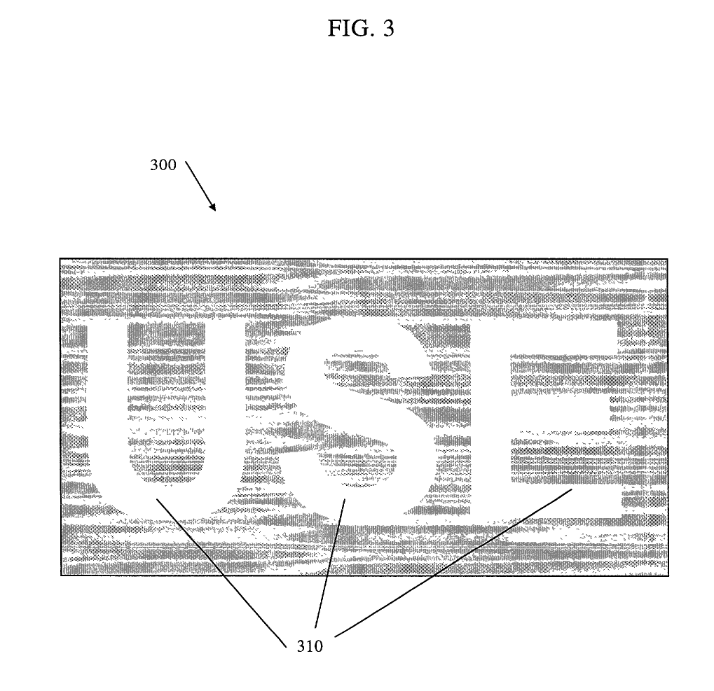

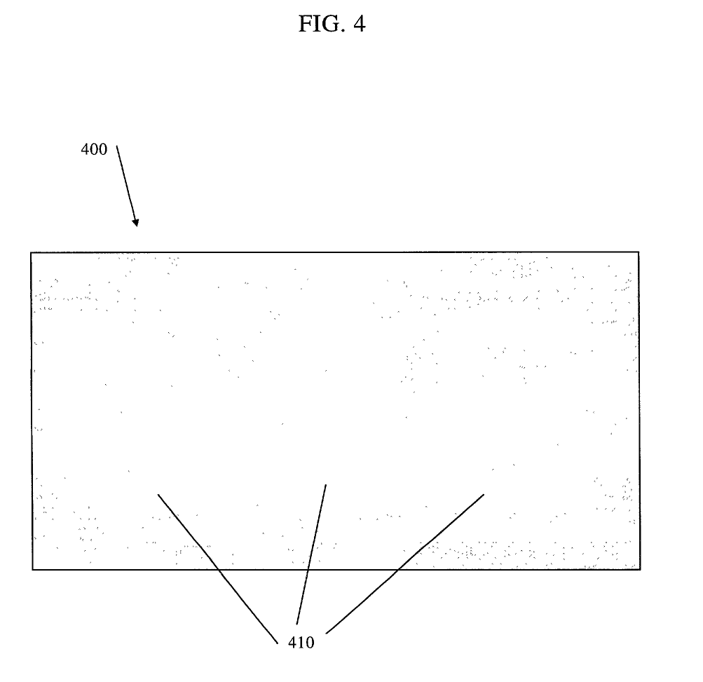

FIGS. 3-5 depict vehicles light lenses as viewed from the rear of the vehicle. When the vehicle lights are not illuminated, the message logo portion 310 of the present invention vehicle light lens 300 may or may not be visibly discernible depending on the materials incorporated into the message logo portion (see FIGS. 3 and 4, respectively). FIG. 3 shows a lens 300 having a light reflective message logo portion 310 that spells the word “USE.” Thus, when light (natural or man-made) 280 is directed at the message logo portion 310 of the present invention lens 300, the message logo portion 310 of the lens 300 reflects the light and becomes visibly discernible during the day when vehicle lights generally are not illuminated. The reflective material causes the reflected light from the message logo portion 310 to be either brighter or darker than the surrounding lens material to create a contrast in order to see the message logo 310.

In the embodiment depicted in FIG. 4, the message logo portion 410 of the vehicle light lens 400 is not reflective and not visibly discernible. However, in alternative embodiments where the message logo portion 410 of the vehicle light lens 400 is formed from a material having a noticeably different color or texture than the remaining portion of the lens, the non-reflective message logo portion 410 of the vehicle light lens 400 may be visibly discernible without illumination from the vehicle lights and the difference in color is accentuated when illuminated.

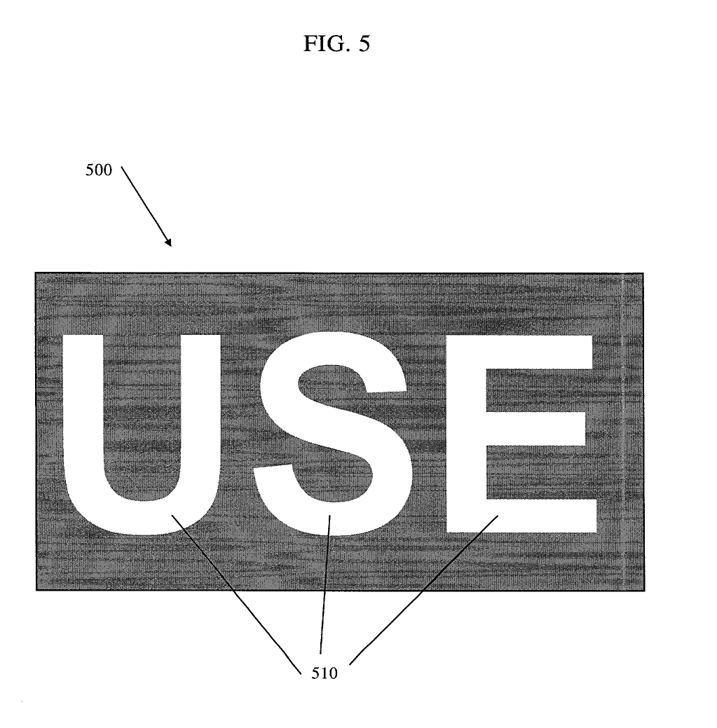

In FIG. 5, the vehicle lights are illuminated thereby causing the message logo portion 510 of the vehicle light lens 500 to become visibly discernible from the observer facing side of the vehicle light lens body 500.

Generally, the present invention vehicle light lens may be manufactured by injection molding methods known by those skilled in the art. More specifically, such methods include the use of a mold having a contrast forming topography and at least one layer. Molds having a contrast forming topography will generally form a lens body having varying thicknesses. Generally, the message logo portion of the lens body will have a raised edge perimeter that encloses an interior layer having a thickness less than the remaining portion of the lens body. Multi-layered molds will generally be used to form a lens body having multiple materials or varying colors. Multi-layered molds will be injected utilizing a process that forms the mold's layers into a one-piece lens body.

In addition, the present invention message logo portion of the vehicle light lens body is incorporated into or molded into the vehicle light lens body thereby creating a one-piece vehicle light lens capable of displaying message logos. The present invention message logo portion may be integral to or permanently affixed to the lens body. A one-piece lens simplifies installation, increases durability, and avoids the complications that often accompany multi-piece assemblies.

In addition, the inclusion of multiple materials in the present invention vehicle light lens and the use of molds that create surface finishes are included as part of the present invention. One example of a vehicle light lens having multiple materials is a lens having both reflective and non-reflective materials. Another example is a lens having multiple colors or areas with varying degrees of transparency. In addition, the lens may have areas with varying surface finishes. For example, the message logo portion of the vehicle light lens may have a textured surface finish to make it more visibly discernible.

One example of an embodiment where the message logo is permanently affixed to the lens body is where a “sticker” or “decal” bearing a message logo is permanently affixed to a surface of the lens body. Such stickers could include reflective and non-reflective materials and materials with varying transparency.

An embodiment of the present invention and many of its improvements have been described with a degree of particularity. It should be understood that this description has been made by way of example, and that the invention is defined by the scope of the following claims.

What is claimed is:

1. A vehicle light lens for displaying at least one message logo, said lens comprising:
a body with an observer facing side and an opposite light source facing side; and
at least one contrast visible from said observer facing side;
wherein said at least one contrast is incorporated with said body and
said at least one contrast creates said at least one message logo.

2. The vehicle light lens as defined in claim 1, wherein:
said at least one contrast is integral to said body.

3. The vehicle light lens as defined in claim 1, wherein:
said at least one contrast is permanently affixed to said observer facing side of said body.

4. The vehicle light lens as defined in claim 1, wherein:
said at least one contrast is permanently affixed to said light source facing side of said body.

5. The vehicle light lens as defined in claim 1, wherein said at least one contrast reflects light.

6. The vehicle light lens as defined in claim 1, wherein said lens is positioned adjacent to a light source, said at least one contrast is illuminated when said light source is directed at said at least one contrast on said light source facing side of said body.

7. The vehicle light lens as defined in claim 1, wherein said message logo is “USE TURN SIGNALS”.

8. The vehicle light lens of claim 1, wherein said vehicle light lens is included in a brakelight assembly.

9. A method of manufacturing a vehicle light lens for displaying message logos, comprising:
providing a mold with a contrast forming topography, said topography forming a contrast that creates said message logo; and
injecting at least one material into said mold.

10. A method of manufacturing a vehicle light lens for displaying message logos, comprising:
providing a multi-layered mold with a contrast forming topography, said topography forming a contrast that creates said message logo; and
injecting at least one material into said mold.

11. The method in claim 9, wherein said mold provides said lens with a surface finish.

12. The method in claim 10, wherein said mold provides said lens with a surface finish.
